(19) United States
(12) Patent Application Publication
(10) Pub. No.: US 2012/0279981 A1
(43) Pub. Date: Nov. 8, 2012

(54) PROCESS FOR STORING AND RETRIEVING ROLLED FLEXIBLE BAGS FROM A DISPENSERPROCESS FOR STORING AND RETRIEVING ROLLED FLEXIBLE BAGS FROM A DISPENSER

(75) Inventors: Jamie Grace Thomas, Milwaukee, WI (US); William D. Price, Midland, MI (US); Robert J. Nestle, Essexville, MI (US); Randall W. Friebe, Bay City, MI (US); Katherine N. Bouchey, Milwaukee, WI (US); Jonathan D. Bellante, Milwaukee, WI (US); Kirsten Jane Climer, Brooklyn, NY (US); Charles Paradise, Brooklyn, NY (US); Brook S. Kennedy, Glen Ridge, NJ (US); Lauren Argo, Brooklyn, NY (US); Phillip Randolph Hartley, Brooklyn, NY (US); Shailesh H. Patel, Wilmette, IL (US); Gina Reynolds, Chicago, IL (US); Erin L. Myers, Chicago, IL (US); Jason P. Grochowski, Crown Point, IN (US)

(73) Assignee: S.C. JOHNSON & SON INC., Racine, WI (US)

(21) Appl. No.: 13/304,019

(22) Filed: Nov. 23, 2011

Related U.S. Application Data
(63) Continuation-in-part of application No. 13/100,367, filed on May 4, 2011.

(51) Int. Cl. B65G 59/00

(52) U.S. Cl. 221/1

(57) ABSTRACT

A process of storing and retrieving recloseable storage bags including the steps of purchasing a package of individualized recloseable storage bags from a retailer, removing the recloseable storage bags from the package, optionally providing the recloseable storage bags in a roll form, inserting the roll of recloseable storage bags into a dispenser having compartments. The dispenser has a lid with access slots juxtaposed over the compartments. The process further includes removing the recloseable storage bags from the dispenser through the one or more access slots. The process may also include providing a merchandiser having different types of bags packaged as refills in flexible bags. Instructions with the merchandiser and/or the storage dispenser may direct consumers to replenish the storage dispenser with different types of bags.

### CROSS REFERENCE TO RELATED APPLICATIONS

This application claims priority to and is a continuation-in-part of U.S. Utility patent application Ser. No. 13/100,367, filed May 4, 2011, which is incorporated herein by reference.

### FIELD OF THE INVENTION

The subject disclosure relates to a method and apparatus for providing recloseable storage bags to consumers, particularly the subject disclosure relates to a system for providing a delightful consumer experience from the beginning through to the end of a user-experience when a consumer purchases, stores, and/or dispenses recloseable storage bags.

### BACKGROUND OF THE INVENTION

There is increasing competition for consumers' business. Consumers have a large number of options in many fields, such as home storage. Producers of home storage products, such as plastic food bags, have not recognized or addressed improving upon the manufacturing, display for sale, presentation for access at the point of use (e.g., dispensing), and refill. As such, room for improvement in the life cycle of many products remains.

Major producers of such recloseable storage bags have made a number of strides to differentiate themselves from a purely technical aspect by providing, inter alia, freezer optimized usage, distinctly colored closure strips, optimally spaced zippers, clicking zippers, and highly functionalized slider closures. While many of these technical advancements have provided good points of differentiation, unbranded bags have continued to make significant headway into the market share for plastic recloseable storage bags.

Thus, there is a need for a system or method for marketing or providing recloseable storage bags in such a way that the consumer is provided with an overall experience that clearly differentiates itself from those provided by unbranded producers. In particular, there is a need for a system or method for marketing or providing recloseable storage bags in such a way that addresses currently unmet user needs that are not fixable through technical changes to the bag alone—that is, providing the user with a better overall experience from the retail shelf to an in-use occasion.

### SUMMARY OF THE INVENTION

In a first non-limiting embodiment, the present technology is directed to a process for providing a recloseable storage bag to a consumer wherein the process comprises the steps of: (a) providing a plurality of recloseable storage bags; and (b) directing consumers to load the plurality of recloseable storage bags into an in-home dispenser.

In a second non-limiting embodiment, the present technology is directed to a process for providing a recloseable storage bag to a consumer wherein the process comprises the steps of: (a) providing a plurality of recloseable storage bags in a flexibly wrapped package; wherein the flexibly wrapped package is substantially cylindrical; and (b) directing consumers to load the plurality of recloseable storage bags into an in-home dispenser.

In a third non-limiting embodiment, the present technology is directed to a process for providing a recloseable storage bag to a consumer wherein the process comprises the steps of: (a) providing a plurality of recloseable storage bags; and (b) directing consumers to load the plurality of recloseable storage bags into an in-home dispenser; wherein the in-home dispenser comprises one or more compartments.

In another embodiment, the subject technology is directed to a method of providing a storage dispenser for dispensing re-sealable bags to consumers. The method includes the steps of providing a merchandiser, wherein the merchandiser contains at least three different types of bags packaged as refills, wherein the different types of bags are packaged as a plurality of bags within a flexible bag. The method also includes providing storage dispensers associated with the merchandiser, wherein each storage dispenser includes: a base having at least two dividers that define at least three compartments; and a lid coupled to the base for selectively enclosing the at least three compartments and defining an access slot for each compartment. Still further, the method includes providing a set of instructions with at least one of the merchandiser and the storage dispenser for directing the consumers to replenish a storage dispenser with the at least two different types of bags.

The refills may be provided as a roll within a single use flexible bag and the single use flexible bags are provided with a peelable opening that creates an audible sound upon opening. The method also may include pre-filling the merchandiser and the storage dispenser with refills for display and sale in a retail environment.

The set of instructions can direct consumers to (i) purchase at least one refill, (ii) open the lid, (iii) open the refill, (iv) place contents of the opened refill into one of the compartments, (v) close the lid onto the base, and (vi) remove one or more refill bags through the slot associated with the compartment. In a preferred embodiment, when in a closed position, a length of the storage dispenser is approximately from 8 inches to approximately 14 inches, a width of the storage dispenser is from approximately 6 inches to approximately 12 inches, a height of the storage dispenser is less than approximately 3 inches so that the storage dispenser fits in most drawers in two orientations, and the storage dispenser two slots being approximately 170 mm by 23 mm and the third slot being approximately 260 mm by 23 mm, each access slot including a central extension void that is approximately 57 mm wide for allowing pinch and grabbing of the bags in the associated compartment.

The lid preferably has a single latch for securing the lid closed to the base with an audible noise to notify to the consumer that the storage dispenser is closed and allowing for single handed opening of the storage dispenser. Each compartment of the base may conforms to a cylindrical shaped refill with or without dividers that are adjustable in slots defined by the base and sized to prevent migration of the bags between compartments.

The lid could be substantially translucent to allow the consumer to view the compartments, include brand information to at least partially cover planned dead space within the base, and define a circular depression adjacent each access slot for applying an identification label. The access slots may: have a length selected to intuitively cue the consumer to know a bag size associated with the respective compartment; are sized and shaped to provide resistance during bag removal yet allow replacing a bag into the associated compartment; and include flared polished edges.

Another embodiment of the subject technology is directed to a retail display including a plurality of small bags packaged as small refills in a plurality of flexibly wrapped packages that are substantially cylindrical and have a first length, a plurality of large bags packaged as large refills in a plurality of flexibly wrapped packages that are substantially cylindrical and have a second length, wherein the second length is longer than the first length, a merchandiser having a plurality of dispensing channels, wherein at least one dispensing channel is sized to accommodate the small refills and at least one dispensing channel is sized to accommodate the large refills, a plurality of storage dispensers that are co-branded with the merchandiser, wherein each storage dispenser includes: a base having at least two dividers that define at least three compartments including a small compartment sized to accommodate the small refills and a large compartment sized to accommodate the large refills, and a lid coupled to the base and defining an access slot for each compartment wherein a small access slot provides access to the small compartment and a large access slot provides access to the large compartment, and a set of instructions associated with at least one of the merchandiser and the storage dispenser for directing consumers to replenish the storage dispenser by purchasing the small and large refills.

In the retail, the plurality of small bags may be sandwich bags and the plurality of large bags may be freezer storage bags. The retail display preferably includes a plurality of medium bags packaged as medium refills in a plurality of flexibly wrapped packages that are substantially cylindrical and have the first length, wherein the plurality of small bags are snack bags, the plurality of medium bag are sandwich bags and the plurality of large bags are freezer storage bags. The small and large bags, once placed in the storage dispenser, are preferably in a substantially symmetrical configuration about the cross-machine direction in the compartment. Once loaded in the storage dispenser, bag closures on the bags of the refills may be on a same relative side of the bag.

A volume insert may be provided for at least one of the compartments of the storage dispenser. The volume insert is selected from the group consisting of a semi-cylinder, a folded planar sheet, and a planar sheet with at least two folds. The merchandiser may provide the refills to the respective dispensing channel with a gravity-fed mechanism.

The set of instructions can direct a consumer to load the refills in the storage dispenser so that a third edge of the bag and a side adjacent to an opening of each bag are on a relative underside of the bag with respect to the lid. The set of instructions can also direct a consumer to load the refills in the storage dispenser so that the respective bags are all facing a same side and wherein the bag closures are staggered and facing towards the respective access slot.

Still another embodiment of the subject technology is directed to a process of storing and retrieving recloseable storage bags including the steps of purchasing a package of two or more individualized recloseable storage bags from a retailer, removing the two or more recloseable storage bags from the package, optionally providing the two or more recloseable storage bags in a roll form, inserting the roll of recloseable storage bags into a dispenser having one or more compartments, the dispenser further comprising a lid wherein the lid comprises one or more access slots juxtaposed over the one or more compartments, and removing one or more recloseable storage bags from the dispenser through the one or more access slots.

The process may include packaging the individualized recloseable storage bags in a flexible-wrapped pouch, wherein the lid encloses the compartments and is hinged to open and close by one-handed operation. Preferably, the dispenser weighs at least 60 grams per compartment in order to allow one-handed removal of a recloseable storage bag. The typical dispenser has three compartments and weighs at least 180 grams. Each compartment may weigh more or less than 60 grams such as at least 70 grams per compartment, at least 80 grams per compartment and the like.

The roll is preferably sized and configured to frictionally engage the dispenser from a first dispensed bag to a last dispensed bag so that only one-handed dispensing is necessary. If the recloseable storage bags include zipper closures, the zipper closures can be stacked so that the zipper closures are aligned, folded at a bottom end evenly onto a mouth of the recloseable storage bags, folded in the middle again and formed into a roll.

The roll may be banded to maintain a desired shape. Typical banding is an elastic band, a paper or cardboard strip formed into a circle, a paper clip, a flexible wrapping pouch, and combinations thereof. Each zipper is positioned to provide gripping tension for the user when removing a recloseable storage bag from the dispenser through the respective access slot. In one embodiment, the dispenser is molded plastic.

Another embodiment of the subject technology is directed to a process of providing recloseable storage bags to a consumer including the steps of: a) providing a package of two or more individualized recloseable storage bags from a retailer; b) directing the consumer to remove the two or more recloseable storage bags from the package; c) directing the consumer to insert the roll of recloseable storage bags into a dispenser having one or more compartments, the dispenser further comprising a lid wherein the lid comprises one or more access slots juxtaposed over the one or more compartments; and d) directing the consumer to remove one or more recloseable storage bags from the dispenser through the one or more access slots. The process may further include the step of directing the consumer to provide the two or more recloseable storage bags into a roll form.

### BRIEF DESCRIPTION OF THE DRAWINGS

FIG. 1 provides a perspective view of one embodiment of an exemplary recloseable storage bag according to the Prior Art.

FIG. 2 provides a cross-sectional view of one embodiment of a box containing recloseable storage bags along line 2-2 of FIG. 3 according to the Prior Art.

FIG. 3 provides a perspective view of an exemplary embodiment of a box according to the Prior Art.

FIG. 4 provides a flow chart of one embodiment of a process for providing recloseable storage bags to a consumer according to the present technology.

FIG. 5 provides a perspective view of an embodiment of a flexibly wrapped package of recloseable storage bags according to the present technology.

FIG. 6(a) provides a perspective view of an embodiment of a base of an in-home dispensing unit according to the present technology.

FIG. 6(b) provides a perspective view of an embodiment of a base and lid of an in-home dispensing unit according to the present technology.

FIG. 6(c) provides a perspective view of an embodiment of a volume insert according to the present technology.

FIG. 7(a) provides a side view of an embodiment of a symmetrically folded bag according to the present technology.

FIG. 7(b) provides a side view of an embodiment of a symmetrically folded bag loaded into a dispensing device taken along line 7(b)-7(b) of FIG. 6(b). according to the present technology.

FIG. 8 provides a side view of an embodiment of a plurality of recloseable storage bags about a shape holder according to the present technology.

FIG. 9(a) provides a side view of an embodiment of a plurality of recloseable storage bags in a staggered configuration according to the present technology.

FIG. 9(b) provides a side view of an embodiment of a plurality of recloseable storage bags in a staggered configuration according to the present technology.

FIG. 10 provides a perspective view of an embodiment of a merchandiser according to the present technology.

FIG. 11 provides a perspective view of another embodiment of an in-home dispenser according to the present technology.

FIG. 12 provides a top view of the in-home dispenser of FIG. 11.

FIG. 13 provides a bottom view of the in-home dispenser of FIG. 11.

FIG. 14 provides a front end view of the in-home dispenser of FIG. 11.

FIG. 15 provides a back end view of the in-home dispenser of FIG. 11.

FIG. 16 provides a side view of the in-home dispenser of FIG. 11.

FIG. 17 provides a partial cross-sectional view of a slot formed in the lid of the in-home dispenser of FIG. 11.

FIG. 18 is a rear perspective partial of the lid of the in-home dispenser of FIG. 11.

FIG. 19 provides a perspective view of the base interior with separators and a divider for the in-home dispenser of FIG. 11.

FIG. 20(a) provides a perspective view of a divider for use with the base of the in-home dispenser of FIG. 11.

FIG. 20(b) provides a front view of the divider for the in-home dispenser of FIG. 11.

FIG. 20(c) provides a side view of the divider for the in-home dispenser of FIG. 11.

FIG. 20(d) provides a top view of the divider for the in-home dispenser of FIG. 11.

### DETAILED DESCRIPTION OF THE INVENTION

The present technology is directed to a system and method for providing a user with an ideal experience from the point of purchase to the time of use when she uses a recloseable storage bag. In certain embodiments the system comprises at least three units: (1) a plurality of recloseable storage bags, such as the Ziploc® Brand Quart Sized Storage Bags provided in a flexible, or otherwise minimized outer wrap; (2) an in-store dispenser for providing such flexibly packaged, or otherwise minimized, bundles of storage bags; and (3) a dispensing unit for in-home use wherein the dispenser may be filled or loaded using the bags from the flexibly wrapped plurality. In certain embodiments, the plurality of bags are provided such that upon removal from their flexible, or otherwise minimized, packaging, the bags are immediately loaded into the dispenser wherein the loaded dispenser will neatly provide one bag at a time without having other unwanted bags pop out and such.

### DEFINITIONS

As used herein, the term “recloseable storage bag” or “bag” encompasses a broad range of structures and products designed to contain items, such as meats, cheeses, vegetables, fruits, breads, and the like. A non-limiting example is a zippered plastic bag such as the Ziploc® Brand Sandwich Bag (S.C. Johnson & Son, Inc., Racine, Wis.). It is also apparent that such “recloseable storage bags” may be used to store non-comestibles, such as office supplies, toys, craft material, and household items such as nuts and bolts and various sundry items. In particular embodiments, recloseable storage bags are recloseable food storage bags. In certain embodiments, recloseable storage bags further comprise one or more bag closures. In certain other embodiments, recloseable storage bags are individually separated and do not comprise rolls of bags which may be separated by tearing along perforations, cutting along ends, or otherwise mechanically separating one bag from another as the bags are provided to a user at the point of first use. In another non-limiting embodiment, bags may be quart or gallon sized. One of skill in the art will appreciate that any size of recloseable food storage bag size may be appropriate.

As used herein, “retail location” refers to a grocery store, mass merchandise store, drug store, club store, or other outlet where a consumer may purchase products for use. An online retailer may also provide any of the tangible elements of the present technology such as recloseable storage bags and/or the in-home dispensing unit.

As used herein, “flexibly wrapped package” refers to a container or outer covering for holding a plurality of recloseable storage bags, or other home storage products, together, in which the plurality of retail-storage containers or products is provided for in the retail location at the point of sale to customers. In some non-limiting embodiments, the container or outer covering is not substantially rigid and may comprise materials such as LDPE, LLDPE, HDPE, BOPP, or other polyolefin resin blend. In yet another embodiment, a flexibly wrapped package is a package which has less internal volume compared to a traditional box. For example, in a particular non-limiting embodiment, a flexibly wrapped package has less volume than a box, or rectangular prism, of the same width. Non-limiting examples are cylindrical prisms, triangular prisms, octagonal prisms, hexagonal prisms, and the like. In certain other embodiments a flexibly wrapped package is cardboard or another paper-based material.

As used herein, “in-home dispensing device” refers to a refillable box, container, or other device which may be provided with a plurality of recloseable storage bags wherein the recloseable storage bags may be dispensed in a manner that minimizes consumer dissatisfaction. In a non-limiting embodiment, an in-home dispensing device may be designed to provide for the dispensation of multiple sizes of recloseable storage bags or multiple openings or areas for dispensation of the like-sized recloseable storage bags. Exemplary in-home dispensing devices are discussed in greater detail herein.

As used herein, “retail dispenser” refers to a container or other device which may be provided at the retail point of sale wherein the device may store or retain a plurality of packages. In certain embodiments, a retail dispenser may provide individual packages upon dispensation to a consumer, the packages containing products such as flexibly wrapped packages having recloseable storage bags, for retail sale. A retail dispenser may or may not be refillable at the retail location. Exemplary retail dispensers are described in U.S. Pat. Nos. 3,356,279, 4,401,255, and 7,658,317 and are discussed in greater detail herein.

As used herein, “bag closure” generically refers to any integral zipper or slider or other opening and closing a recloseable storage bag. Non-limiting examples of are described in U.S. Pat. Nos. 5,647,100 and 7,137,736 to the S.C. Johnson & Son, Inc. One of skill in the art may appreciate that due to their mechanical nature and due to the need for providing an area that a user may grip, recloseable storage bags have a lump at the point at which the bag closure is located. That is, because of the integral bag closures, a recloseable storage bag may not be perfectly flat. The lump may be as a result of the bag closure or an additional strip, line or the like added for tactile enhancement. In certain embodiments, a bag closure is parallel with the cross-machine direction of the recloseable storage bags. Bag closures do not include drawstrings, handles extending from the recloseable storage bag which may be tied, or unattached mechanical closures, such as clips or twist ties.

Packaging for Recloseable Storage Bags

Many consumers are concerned about the amount of packaging on groceries and consumer items, such as consumer packaged goods, as being over-packaged or having too much outer material for the amount of product contained. While some producers of recloseable storage bags have made a number of strides in providing excellent packaging, such as the S.C. Johnson & Son, Inc. which produces Ziploc® Brand recloseable storage bags, which are constructed from recycled material, there is still an opportunity to provide consumers with a product that even further addresses their concerns about minimizing packaging while at the same time not detracting from their overall experience with the product.

A large part of a consumer's experience with the packaging as it relates to a recloseable storage bag is how the packaging serves as a dispenser for the recloseable storage bag. Many consumers are familiar with the cartons or boxes in which recloseable storage bags are sold. Because the box also serves as a dispenser, consumers often put multiple open boxes into a drawer or cabinet space to provide the different bags that a consumer may need. Unfortunately, the boxes are often tossed around with normal dispensing of bags causing a lack of organization, confusion and delay in the future accessing of bags from the drawer or cabinet space.

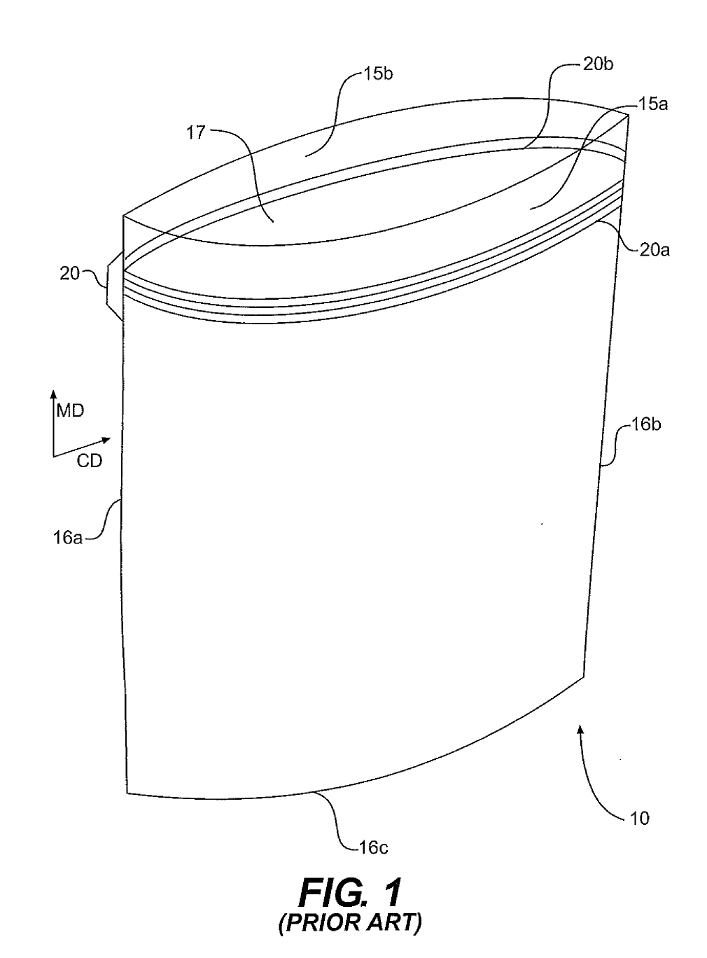

FIG. 1 provides a perspective view of an exemplary embodiment of a recloseable storage bag 10 which is available on the market. The recloseable storage bag 10 comprises a machine direction (MD) and a cross-machine direction (CD). Additionally, the recloseable storage bag 10 has a first side 15a and a second side 15b that are in a coplanar orientation. The recloseable storage bag 10 is sealed along a first edge 16a, a second edge 16b, and a third edge 16c. There is an opening 17 between the first side 15a and second side 15b. The bag may also comprise a bag closure 20. In the embodiment shown in FIG. 1, the bag closure 20 comprises a first closure element 20a that may be disposed along the first side 15a near the opening 17. A second closure element 20b may be disposed along the second side 15b opposite to the first closure element 20a such that the first closure element 20a and second closure element 20b may be put into mechanical communication, or otherwise mechanically engageable.

One of skill in the art will appreciate that the first and second closure elements 20a, 20b may be of any feature type that is appropriate for the recloseable storage bag's intended application such as is exemplified in U.S. Pat. Nos. 5,647,100 and 5,722,128 to S.C. Johnson & Son., Inc. Further still, one of skill in the art will appreciate that the recloseable storage bag 10 may not have first and second closure elements (20a, 20b), but may be closed by another means, such as, but not limited to: sliders, adhesive, hook-and-loop fasteners, and the like.

In many commercial operations, a recloseable storage bag may be formed according to methods and using equipment such as those described in U.S. Pat. Nos. 5,405,561; 5,554,250; 5,544,471; and 5,890,344. Generally, sandwich and freezer bags require special substantially airtight and/or leakproof closing mechanisms. Bags with such closing mechanisms create processing requirements that prevent forming the bags on a perforated roll. Further, bags that are formed as perforated rolls are unsuitable for such applications as freezer and sandwich bags.

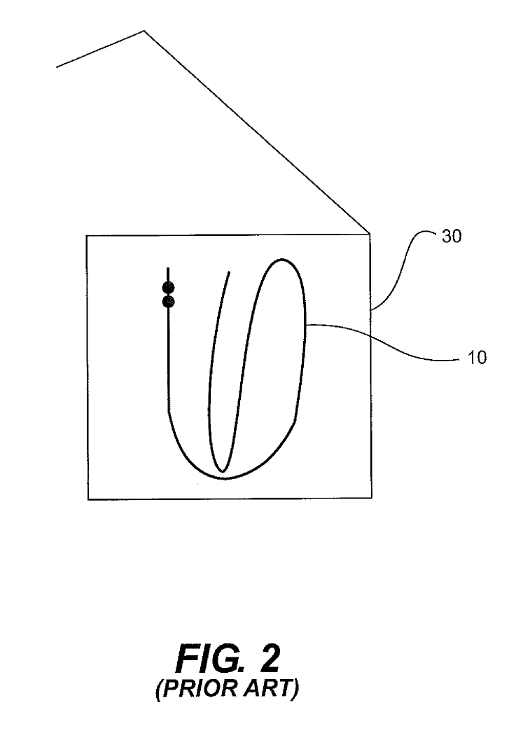

Upon manufacture, a stack of bags may then be double C-folded by an automated system and then stuffed into a carton or box for shipment to a retail location for sale. Despite automation, it is thought that there is a certain level of consistency in how bags are oriented in a box once the filled box reaches consumers due to the inherent amount of free space there is in a box. Further, the double C-folding technique which most automated processes use provides for non-aligned zippers on the bags and/or asymmetry of the bags during dispensing due to the inherent movement of the bags in the box. Both of which are thought to have a certain impact on the way in which a recloseable storage bag is dispensed from a box. FIG. 2 provides an exemplary cross-sectional view of a box 30 taken along line 2-2 (FIG. 3) having a plurality of double C-folded bags 10.

FIG. 3 provides a perspective view of an exemplary embodiment of an existing storage/dispensing box 30 in which recloseable storage bags 10 may be loaded into for retail distribution and sale. The box 30 may arrive for sale at a retail location in a completely sealed configuration. The box may comprise perforations, lines of weakness, or some other means by which recloseable storage bags 10 contained inside may be exposed for consumer access. Upon tearing of the box 30 along the perforations, an opening 37 provides access to the recloseable storage bags 10. As stated herein, consumers have difficulties accessing only one bag at a time when such bags are provided in a box 30, leading to consumer frustration and failure to differentiate experientially from an un-branded product. As stated above, it is thought that many of these difficulties arise from a combination of asymmetry about the point at which a bag may be grabbed by a consumer due to bags shifting in the open space available in the boxes and consumers grabbing multiple layers of film—thereby grabbing multiple bags—at once.

Retail System for Providing a Complete Customer Experience

As stated herein, in alternative to providing some new feature on a product, the present technology surprisingly differentiated itself from existing recloseable storage bag products by providing a superior overall consumer experience for the use of a recloseable storage bag as that experience relates from the retail shelf, to the home, to actual use. More specifically, instead of focusing on a point-solution that improved a single aspect of the technology (i.e., ease of closure, etc.), the entire usage-cycle of a recloseable storage bag is enhanced.

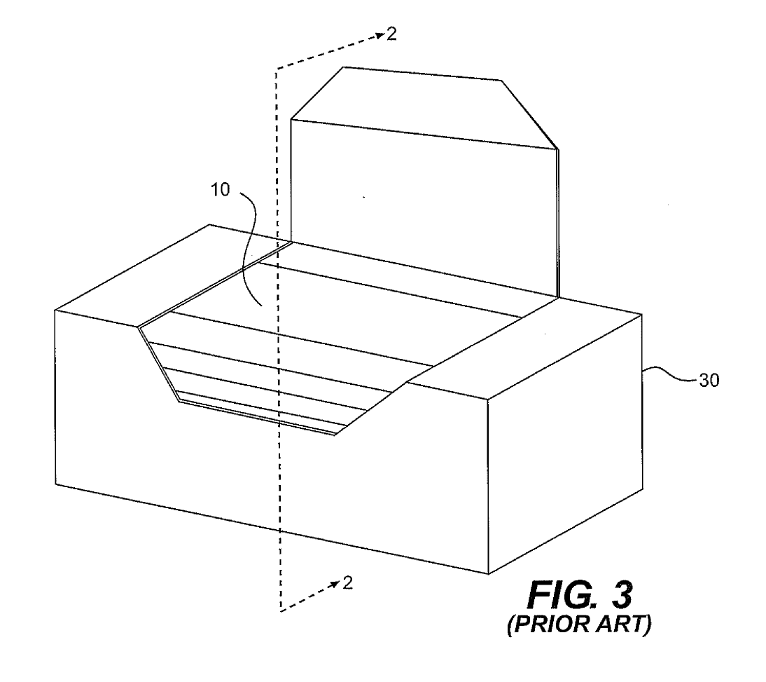

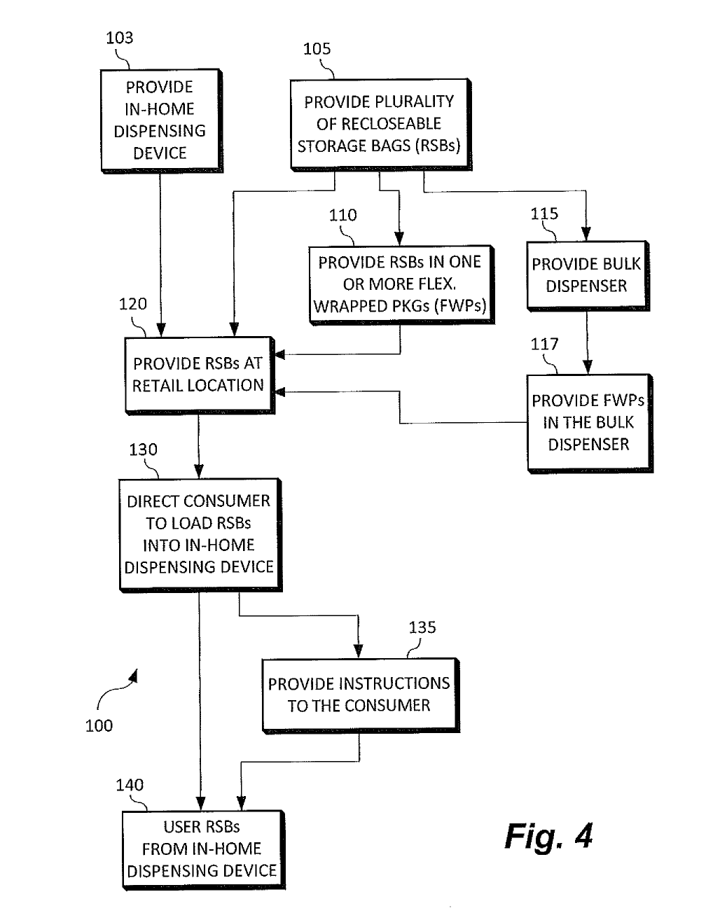

FIG. 4 provides an exemplary flow diagram 100 illustrating the basis for a system, or in the alternative—a method of providing, recloseable storage bags and/or recloseable storage bag refills for an in-home dispensing unit.

A plurality of recloseable storage bags is provided 105. Separately, an in-home dispensing device may be provided 103. Optionally, the plurality of recloseable storage bags (RSBs) provided in 103 may be packaged in one or more flexibly wrapped packages (FWPs) 110. Also optionally, a bulk dispenser may be provided by the producer of the flexibly wrapped RSBs 110 for sale to consumers 115. Without wishing to be limited by any particular embodiment, a bulk dispenser may include a merchandiser as described herein. Optionally still, the flexibly wrapped recloseable storage bags may then be provided in the bulk dispenser at the retail location for sale to customers 117. The recloseable storage bags are then provided for sale to customers at the retail location 120.

In the exemplary embodiment, upon purchase of the recloseable storage bags, the customer may be directed to load the recloseable storage bags into an in-home dispensing device which the consumer has purchased 130 and then to access the recloseable storage bags in the dispenser 140. Once loaded, the consumer may remove recloseable storage bags from the in-home dispensing device. Optionally, a consumer may be provided with instructions on special loading techniques and methods 135 which are described in greater detail herein. Surprisingly, it was discovered that by providing an in-home dispensing system, consumers are delighted by having a relatively high level of organization in their drawer, the ease by which they can access the recloseable storage bags, and the overall good feeling that the consumer may have from purchasing a product with relatively minimized packaging.

Flexibly Wrapped Recloseable Storage Bags

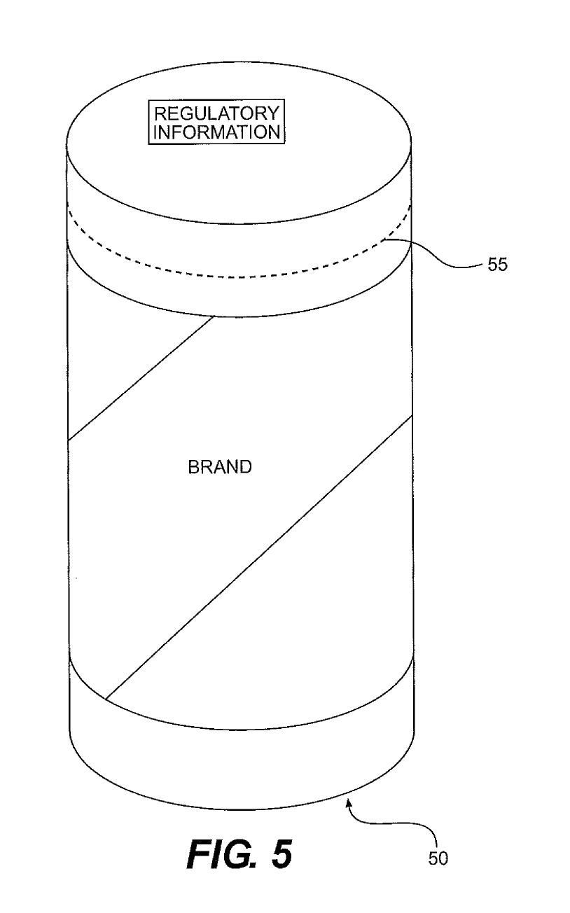

Any suitable automated system for providing an overwrap around consumer goods may be used to provide a flexibly wrapping around a plurality of recloseable storage bags. By providing such a minimized amount of packaging, it is thought that consumers will have a favorable response because of the dramatic reduction in the amount of packaging that they will not have to discard and/or recycle. The flexibly wrapped recloseable storage bag may be made of any suitable plastic or otherwise flexible material, paper, biomaterial and/or recyclable. An exemplary embodiment of a flexibly wrapped plurality of recloseable storage bags 50 is shown in FIG. 5.

In addition to consumer packaging concerns, it is thought that an additional advantage to providing consumers with a flexibly wrapped execution for recloseable storage bags is that consumers will also appreciate that the 360° available for providing graphics will allow for more versatile information and branding opportunities. Further, the packaging reduction will allow the producer to pass on savings to the consumer—leading to an overall increase in utility. In some embodiments, the flexibly wrapped recloseable storage bags may be provided with a perforation, tear strip, point of weakness, or the like to provide ease of access to the consumer. In the embodiment shown in FIG. 5, the flexible wrapping/packaging is provided with a line of perforations 55.

In-Home Dispensing Device

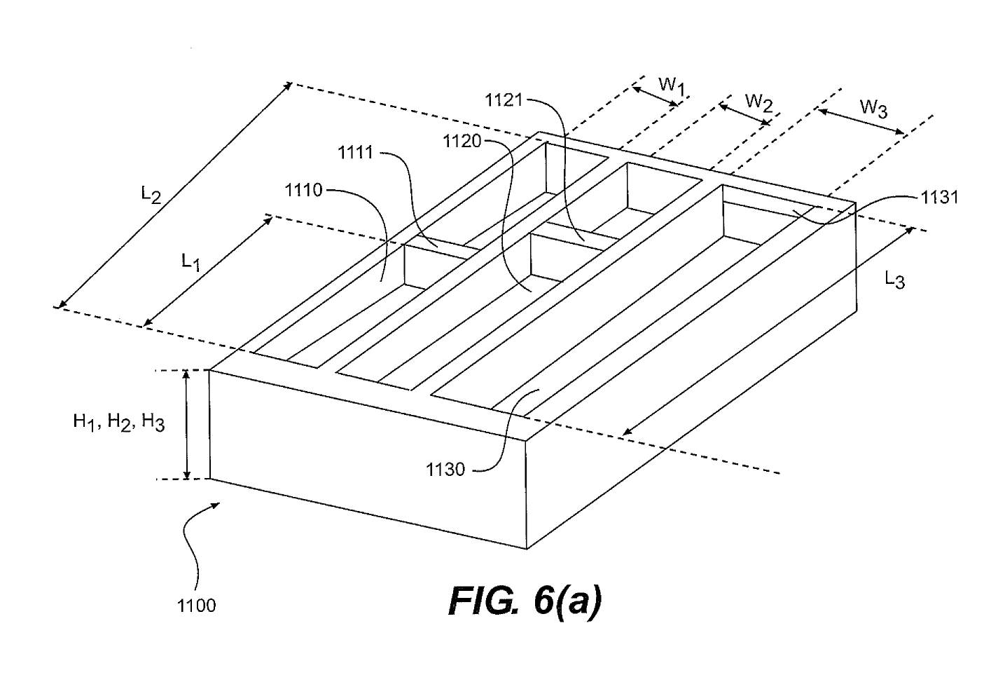

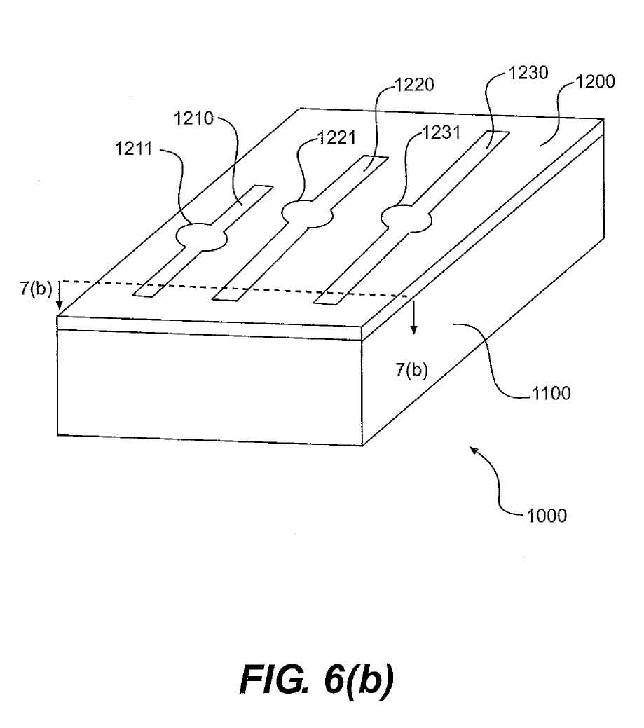

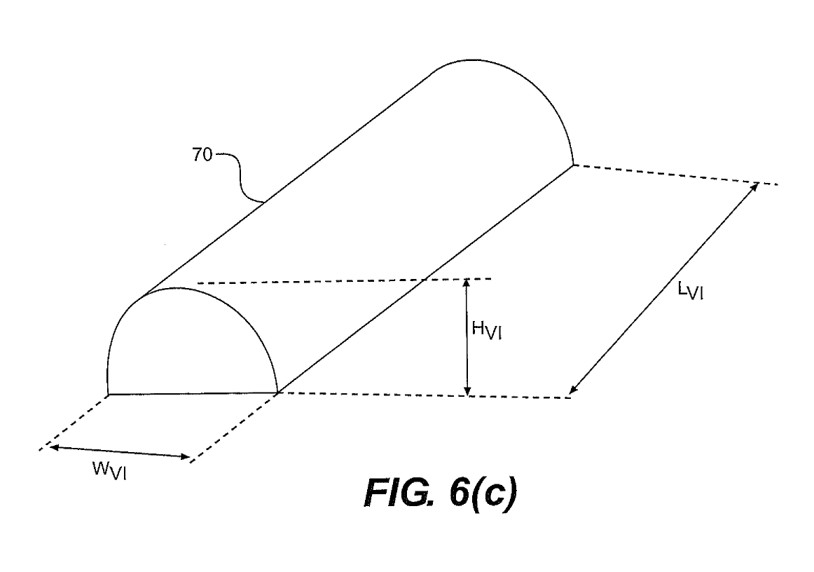

An exemplary embodiment of the base 1100 of an in-home dispensing device for recloseable storage bags is shown in FIG. 6(a). In addition to limitations discussed earlier, it is thought that a major issue that consumers have with existing boxes for recloseable storage bags is that most consumers use multiple types of bags which come in multiple boxes and the boxes may not necessarily tessellate easily and become randomly jumbled after each use. By providing a durable structure for consumers to load/reload, the consumer will not be constantly faced with having to tessellate and re-tessellate her drawer or pantry (or other space where she keeps her recloseable storage bags) which will add to the delight of using recloseable storage bags in day-to-day life. In certain embodiments, the recloseable storage bags are also designed to simply dispense from the in-home dispensing device which will reduce or eliminate any frustration that the consumer feels with many of the existing boxes, such as having multiple unwanted recloseable storage bags inadvertently dispense. Further, by having a durable structure for a dispensing device, packaging for the recloseable storage bags may be greatly reduced as a flexibly wrapped package may be used to provide a plurality of food storage containers to consumers and the consumers may rely on the in-home dispensing device, rather than a mere disposable box, to provide products.

FIG. 6(a) illustrates the base 1100 of an in-home dispensing device 1000 structure having a first compartment 1110, a second compartment 1120, and a third compartment 1130 in which recloseable storage bags may be loaded. One of skill in the art will appreciate that there may be any number of compartments for different (or identical) sized bags. As discussed above, it is thought that by providing a single dispenser for multiple units, then the issue of a consumer's drawer being jumbled will be reduced. In some embodiments, the width of a compartment (W₁ or W₂ or W₃) may be from about 1 inch to about 4 inches.

In some embodiments, the length (L) of a compartment 1110, 1120, 1130 may be from about 3 inches to about 15 inches. In some embodiments, the height (H) of a compartment 1110, 1120, 1130 is from about 1 inch to about 4 inches. The compartments (1110, 1120, and 1130) base 1100 may also comprise removably attached, or slideably attached, spacer (1111, 1121, 1131) which may be used and/or adjusted to hold loaded recloseable storage bags in-place. The base 1100 may be irregularly shaped to provide varying lengths (L) and heights (H) of the compartments 1110, 1120, 1130.

FIG. 6(b) is an exemplary embodiment of a complete in-home dispenser 1000. The dispenser 1000 comprises the base 1100 and a coordinating lid 1200 which may be removably affixed to the base by any suitable means known in the art. The lid 1200 may comprise one or more access slots (1210 or 1220 or 1230) which may provide a consumer with access to recloseable storage bags (not shown) loaded into the dispenser 1000. The access slots (1210, 1220, or 1230) coordinate spatially with the compartments (1110, 1120, or 1130), respectively. The access slots (1210, 1220, or 1230) may also comprise extensions (1221, 1221, or 1231) to provide a relatively easier level of access to the recloseable storage bags. In some embodiments, the access slots have a smaller surface area than the area of the base of the compartments.

It is thought that by providing a refill stream for the dispenser 1000, it may be possible to delight consumers by instructing the consumer to remove the recloseable storage bags from their flexibly wrapped packaging and then loading the recloseable storage bags into the dispensing device (130, FIG. 4). In certain embodiments, instructions may be included, provided or otherwise conveyed in a flexibly wrapped package directing the consumer to an optimal loading configuration. Exemplary optimal loading configurations are described in greater detail herein.

FIG. 6(c) provides an exemplary embodiment of a volume insert 70 which may be removably, or permanently, integrated into a compartment of an in-home dispensing unit. One of skill in the art will appreciate that the height (H_{VI}), width (W_{VI}), and length (L_{VI}) of a volume insert may be specifically tailored to fit each compartment and/or a particular configuration of recloseable bags. As is discussed herein, it is thought that a major drawback to the use of a box (30, FIG. 2) to dispense bags (10, FIG. 1) is that there is a large amount of unoccupied volume between the bags and the enclosure of the box. Due to this fact, the bags shift around during transportation and use, and bags may no longer be properly aligned or optimally aligned for individual bag dispensing despite the box being pre-loaded in a properly aligned, or otherwise optimal, configuration. By providing a volume insert, the free space around bags may be minimized, providing for a better dispensing experience. A volume insert 70 may be optimized for a particular in-home dispenser to provide a tight fit that may not be possible to provide using an automated system.

In some embodiments, a volume insert 70 may be spring-loaded or provide some other means of resistance to provide a relatively consistent amount of volume reduction in each compartment. In some other embodiments, a volume insert may be adjustable in terms of volume so that a user can customize the amount of volume she wants reduced in any compartment.

In-Home Dispenser

As described herein, certain embodiments of the subject technology may further comprise the benefit of individual recloseable storage bag dispensation in addition to the other user benefits (inter alia, reduced packaging, neater shelves/storage spaces, and the like). A volume insert (70, FIG. 6(c)) may be used to minimize the amount of free space in which a plurality of recloseable storage bags may have to become mis-configured or lose a particular configuration whether the storage be on-shelf or in the home.

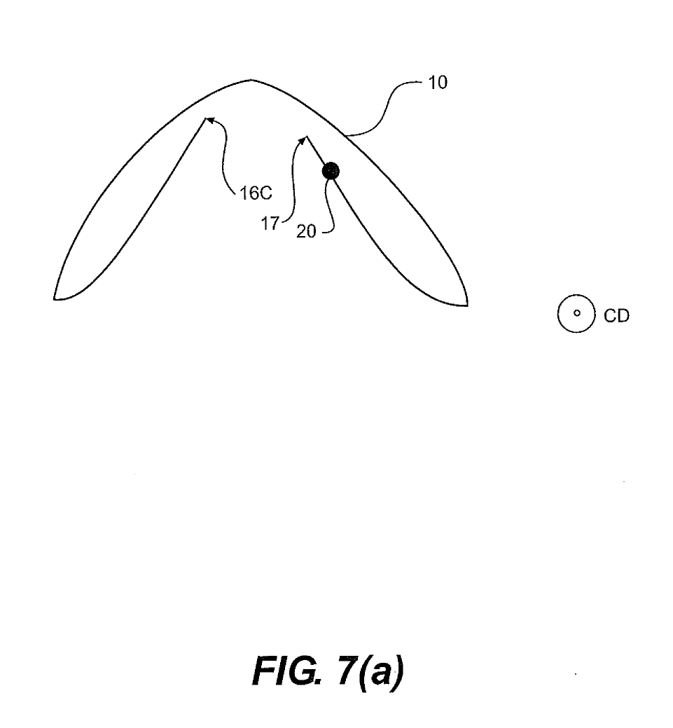

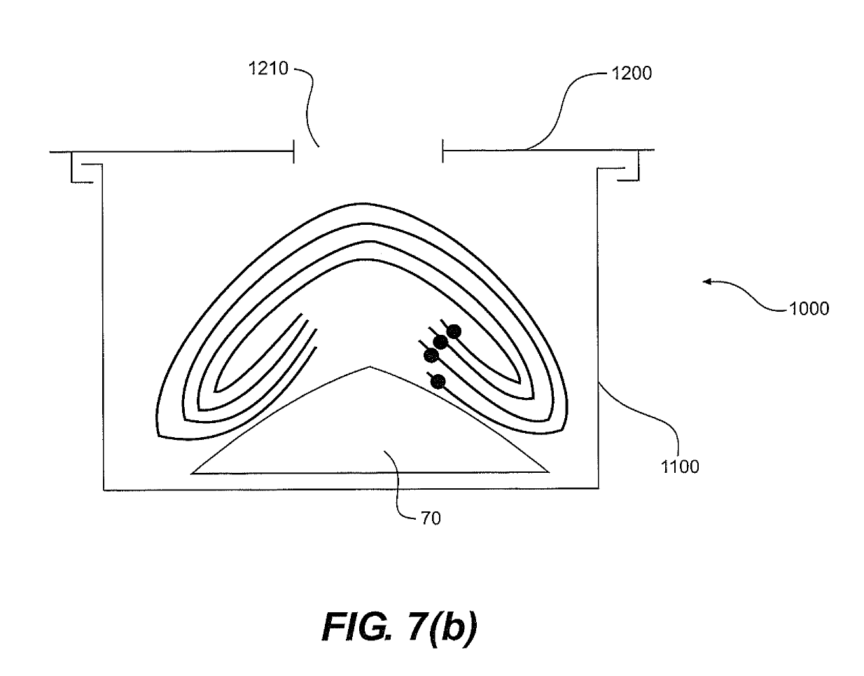

Without wishing to be limited by theory, one configuration which would provide for individual bag dispensation is shown in FIG. 7(a). The bag 10 is substantially symmetrical (bag closure 20 notwithstanding for symmetry purposes) about the center-line of the bag in the cross-machine direction (CD). In FIG. 7(a), the recloseable storage bag is folded such that the closed end or third edge 16(c) and the top end or open end/opening 17 are on the relative underside of the folded bag 10. It is contemplated that the third edge 16(c) and side relatively adjacent to the opening 17 may be on the relative topside of the folded bag 10—the topside being understood to be the side of the folded bag facing relative to the access slot of whatever dispenser is being used. FIG. 7(b) shows a plurality of bags in a stack wherein the bags have been folded into a symmetrical-about-the-CD configuration.

One of skill in the art may appreciate that, while folding and arranging bags along the CD of the bag is preferred, it is possible to apply any configuration described herein in the MD as well.

FIG. 7(b) shows the bags 10 as they may be provided in a dispenser 1000 having a base 1100 and lid 1200. It is thought that a consumer may access bags through an access slot 1210 thereby facilitating a relative symmetrical access to the bags 10 and providing actual individual dispensation of the bags 10. Optionally, a volume insert 70 may be provided to minimize free space in the compartment in which the bags 10 are stored (see FIG. 6(c)).

As is shown in FIG. 7(b), the plurality of bags 10 may be provided such that the recloseable storage bag closures 20 are all aligned or are otherwise configured such that the RSBs 10 are all on the same relative side or edge of the recloseable storage bags 10. An instruction may be provided to configure the recloseable storage bags such that the bag closures 20 are all on the same relative side or edge of the recloseable storage bags 10.

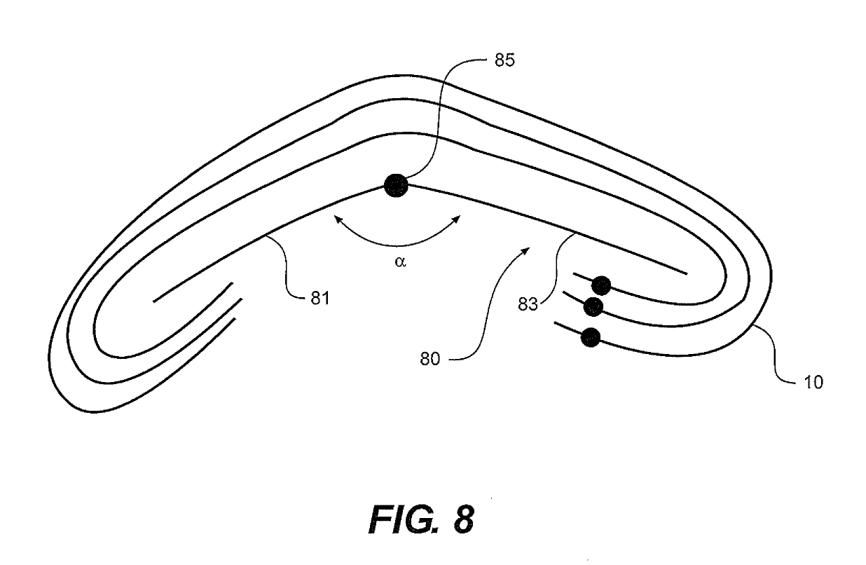

FIG. 8 provides an alternative arrangement by which a plurality of recloseable storage bags 10 may be provided about a shape holder 80. The shape holder 80 may have a first wing 81 and a second wing 83 and a center line 85. It is thought that by arranging the bags 10 such that the machine direction (MD) of the recloseable storage bags 10 is parallel with the center line 85, and by providing the wings (81, 83) such that the third edge 16c and end of the bag 10 with the opening 17 may be folded about the wings (81, 83), when arranged in a compartment in such a way that the bags 10 are facing the access slot of the compartment, then only one bag 10 at a time will be dispensed. In some embodiments, a shape holder 80 may be used in conjunction with a volume insert 70. In other embodiments the wings (81, 83) form an obtuse angle α about the center line 85.

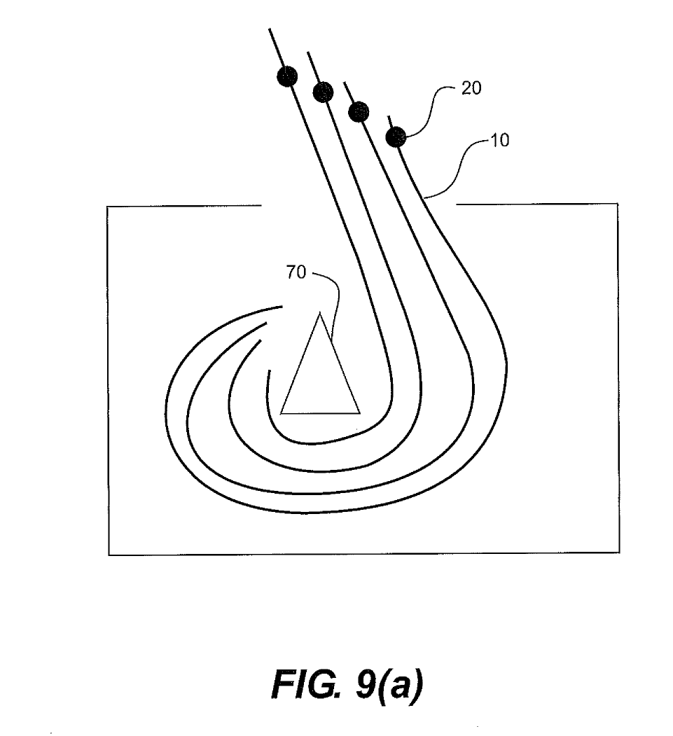

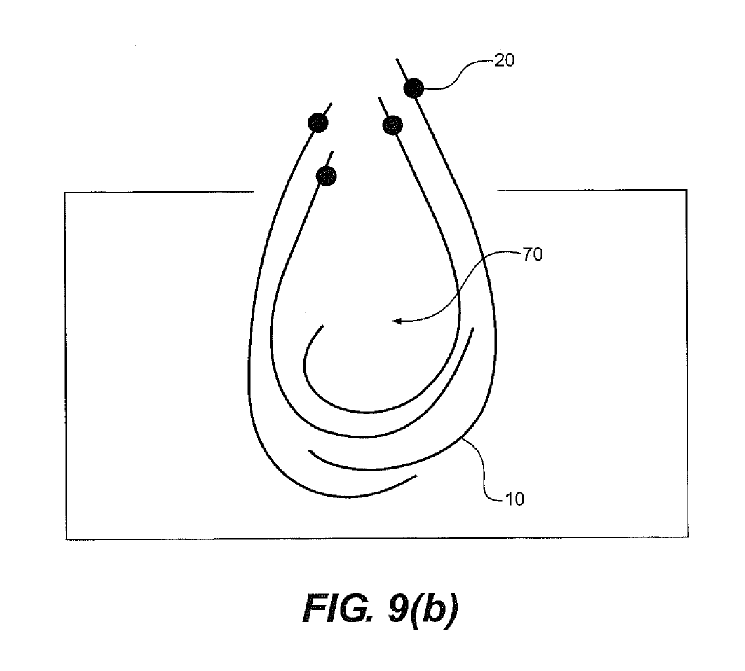

FIG. 9(a) provides an alternative arrangement by which a plurality of recloseable storage bags 10 may be provided such that the bag closures 20 are aligned in the same direction and are staggered. By providing the staggered configuration and then rolling the bags such that they will fit into a compartment, it is thought that such an arrangement will provide the bag closures 20 such that the closures act as handles or grips for the consumer to easily withdraw one bag at a time. In the exemplary FIG. 9(a), the bags 10 are provided such that the bag closures 20 are staggered and the stack of bags 10 is rolled such that the bag closures 20 are provided in a compartment such that the bag closures are relatively accessible to a consumer through an access slot in the manner described herein. An optional volume insert 70 may be used to provide as a stabilizing unit to hold the bags 10 in place to aid in maintaining the bag configuration.

In the exemplary FIG. 9(b), the bags 10 are provided such that the bag closures 20 are staggered and the stack of bags 10 are arranged such that the bag closures 20 are not all arranged in the same direction. In the embodiment of FIG. 9(b) the bags 10 are arranged such that the bag closures 20 are alternating in directions. In FIG. 9(b) the bags 10 is rolled such that the bag closures 20 are provided in a compartment such that the bag closures 20 are relatively accessible to a consumer through an access slot in the manner described herein. An optional volume insert 70 may be used to provide as a stabilizing unit to hold the bags 10 in place to aid in maintaining the bag configuration.

In addition to the configurations described herein, it may be possible to provide the user with recloseable storage bags in a configuration such as C-folded, double C-folded, Z-folded and the like. Exemplary configurations are described in U.S. Pat. No. 5,626,572.

In-Store Dispensing Device

Manufacturers of round canned goods, such as canned soup, often have spring-loaded or gravity-fed shelf units on-shelf at a retail location for dispensing their canned products. Such dispensing units are exemplified herein. A similar dispensing method may be used to dispense a flexibly wrapped package according to the present technology. In one embodiment, it is thought that pre-filled merchandisers may be provided to retailers so that a clerk or stock person at a retail location may simply open a merchandiser according to the producer's directions and the merchandiser will be ready for consumer access.

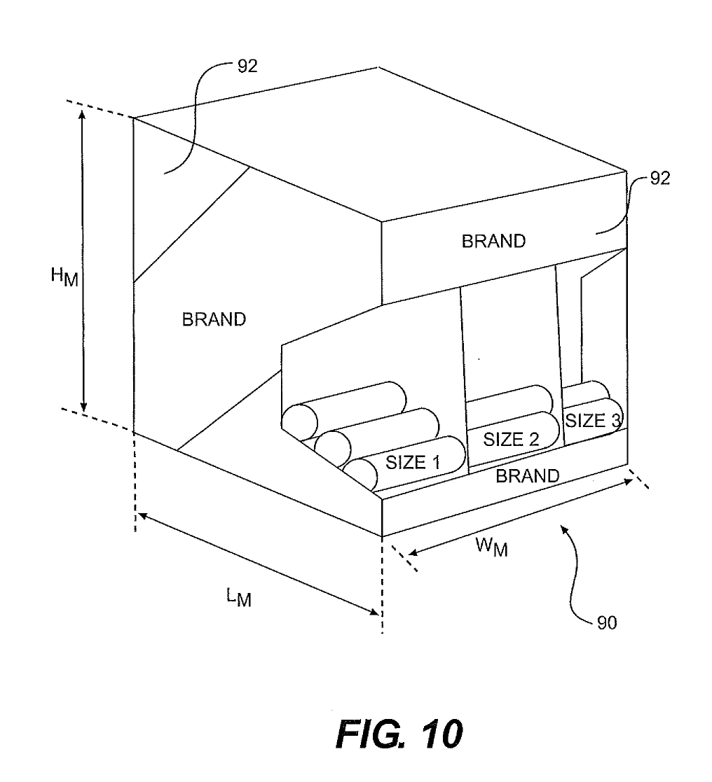

FIG. 10 provides an exemplary embodiment of an opened merchandiser 90. As shown in FIG. 10, the dispensing unit may be substantially enclosed but form several access channels 94. The access channels 94 allow consumers to access one or more sizes of flexibly wrapped recloseable bags with each slot being sized to correspond to the various size bags. The merchandiser may be made of any material such as a corrugated fiberboard, solid fiberboard, chipboard, or the like. In one embodiment, it is thought that it is possible to provide multiple SKUs into a single merchandiser unit, there will be a relatively minimal out-of-stock potential for the merchandiser. In another embodiment, there is only a single SKU per merchandiser.

In one embodiment, the merchandiser 90 may have a height (H_{M}) of from about 5 inches to about 55 inches. In a preferred embodiment, the height is from about 5 inches to about 10 inches. In another embodiment the merchandiser 90 may have a length (or depth) (L_{M}) of from about 5 inches to about 50 inches. In a preferred embodiment, the length is from about 5 inches to about 11 inches. In another embodiment still the merchandiser has a width of from about 5 inches to about 50 inches. In a preferred embodiment, the width is from about 5 inches to about 10 inches. Further, because rather than having a plurality of packages having identical, relatively small, graphics, it will be possible to have a single, relatively large, “billboard” 92 type communication across the merchandiser. It is thought that this will help attract consumers to the display. Communications including, but not limited to, instructions, promotions, QR codes, bar codes, and the like could be prominently displayed on the billboard. In some embodiments, the merchandiser may provide packages using a gravity fed-type mechanism. In other embodiments, the merchandiser may provide packages using a spring-loaded mechanism.

Additional In-Home Dispensers

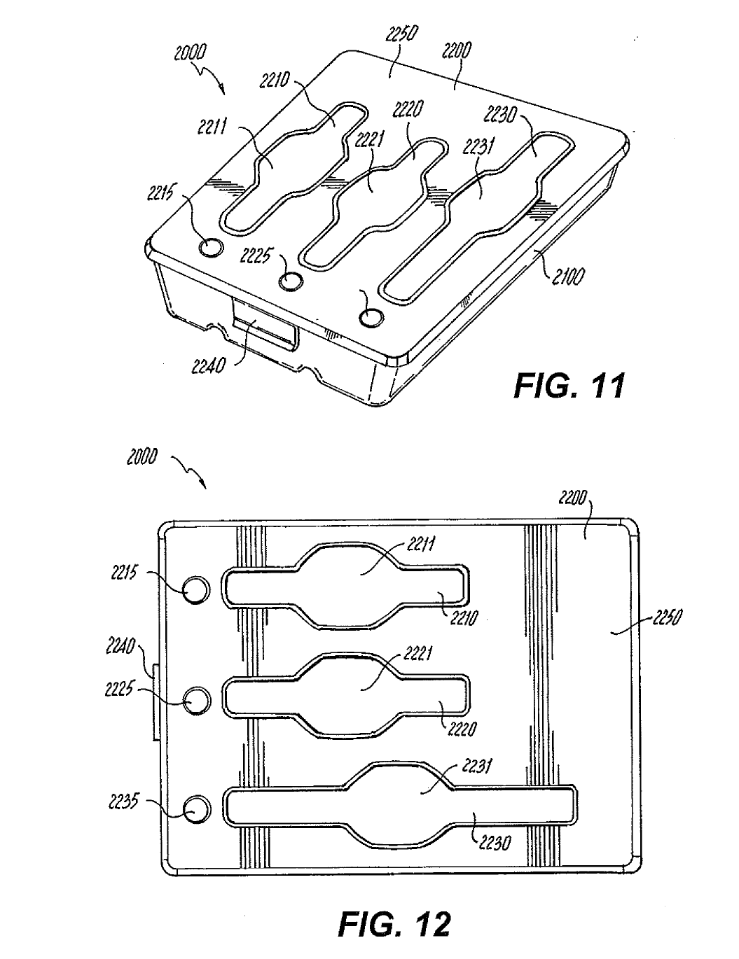

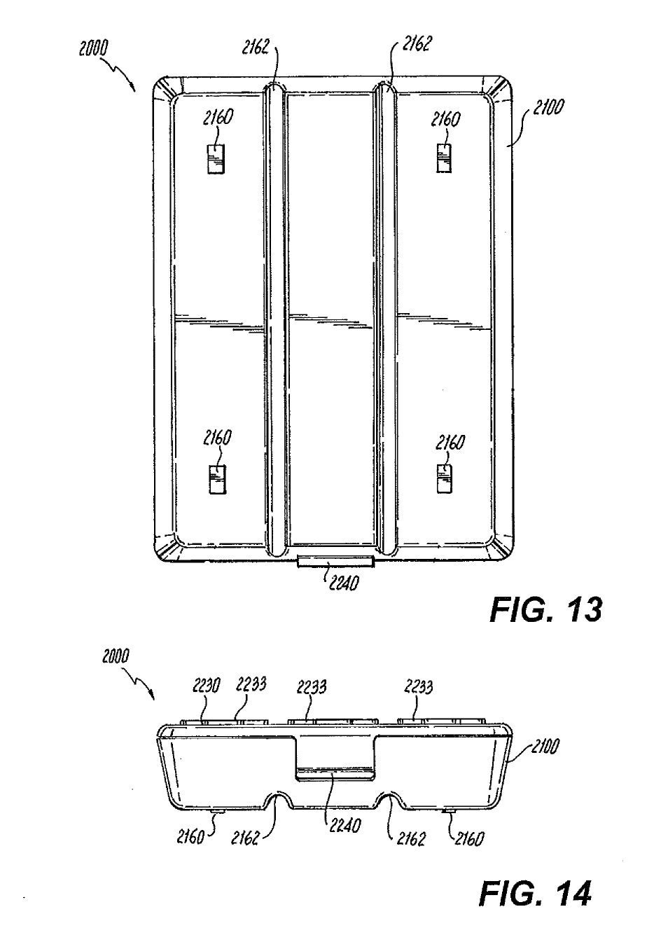

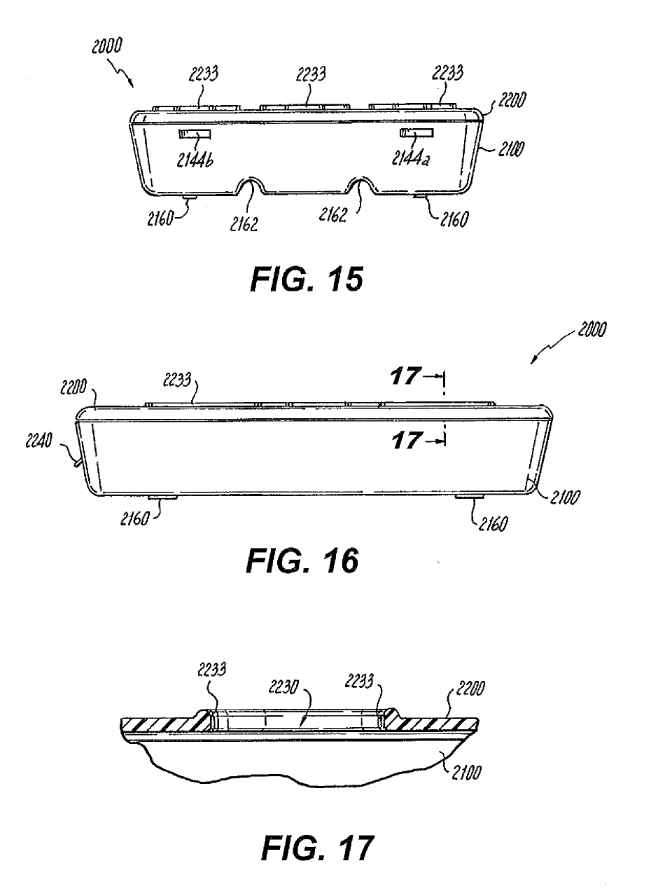

Referring now to FIGS. 11-16, additional views of another in-home dispenser 2000 according to the present technology is shown. As will be appreciated by those of ordinary skill in the pertinent art, the dispenser 2000 utilizes similar principles to the dispenser 1000 described above. Accordingly, like reference numerals preceded by the numeral “2” instead of the numeral “1”, are used to indicate like elements. The dispenser 2000 has been resized and reshaped to have improved ergonomic and aesthetic qualities. Preferably, the dispenser 2000 is fabricated from molded plastic. Like the merchandiser, the dispenser 2000 can be pre-filled with bags and sealed for display and sale in a retail environment. The dispenser 2000 has an area 2250 upon which branding information and/or instructions may be provided.

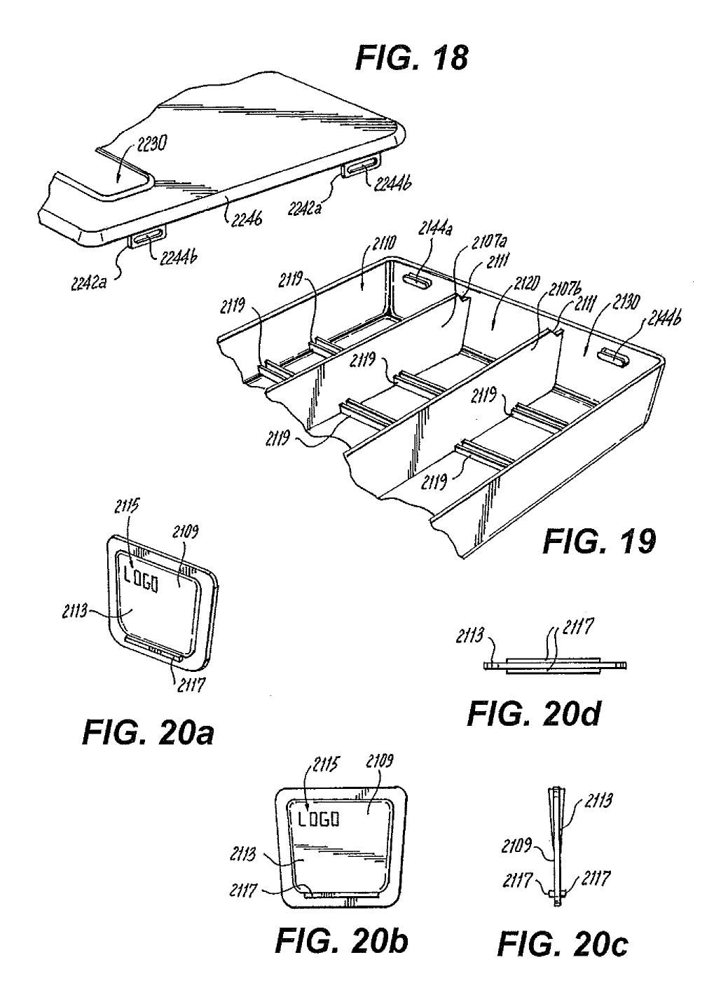

Referring particularly to FIGS. 11 and 12, the lid 2200 also encloses the interior 2105 of the base 2100 and defines three slots 2210, 2220, 2230 for accessing the base interior 2105 best in FIG. 18. The lid 2200 is translucent so consumers can see the contents of the dispenser 2000. Two small slots 2210, 2220 are sized to accommodate small bags such as sandwich and snack bags with corresponding compartments 2110, 2120 as described below. The third large slot 2230 is sized to accommodate large bags such as gallon freezer bags with a corresponding third compartment 2130. In one embodiment, the dispenser 2000 is 12.9×9.25×3 inches. The large slot 2230 is 260 mm long, the short slots 2210, 2220 are 170 mm long, and each slot 2210, 2220, 2230 has a nominal width of 23 mm with central extensions 2211, 2221, 2231 that expand to 57 mm. By having slots that are always open once deployed, the consumer has direct access to the bags stored therein.

The lid 2200 also includes a sticker locator circle 2215, 2225, 2235 for each slot 2210, 2220, 2230. In a preferred embodiment, the lid 2200 is clear or textured while still being translucent so that a consumer can view the contents of the base 2100. However, by applying a sticker (not shown) to the sticker locator circles 2215, 2225, 2235, one can provide additional information for the corresponding compartment 2110, 2120, 2130 such as that snack or sandwich bags are contained therein. The stickers may preprinted with words and/images or provide a writeable surface upon which the consumer may personalize the description. The stickers may be provided with the dispenser 2200 as a unitary package, within the flexible pouch containing refills, or in association with the merchandiser. In another embodiment, the lid 2100 forms a pocket in which slips may be tucked rather than utilizing stickers or other identification means.

In alternative embodiments, the lid 2200 has different slot configurations to correspond to different compartments in the base 2100. For example, the lid 2200 may include a fourth slot above and perpendicular to the two smaller slots 2210, 2220 with a corresponding compartment formed in the base 2100. Each slot in the lid 220 may also vary. Alternative slot shapes include, without limitation, teardrop shaped, the central extension located on one or both ends of the slot, oval, egg shaped, slots oriented diagonally across the lid, rectangular, key-hole, combinations thereof and the like.

Referring now to FIG. 17, a partial cross-sectional view of an exemplary slot 2230 formed in the lid 2200 of the in-home dispenser 2200 is shown. The slot 2230 has a flared edge 2233 that is preferably polished to create a smooth glide of the bag through the slot 2230 during dispensing. By being smooth and polished, the flared edge 2233 also provides a pleasing feel to the consumer. The remainder of the lid 2200 is preferably textured to provide tactile and improved grip to the consumer. As shown, the flared edge 2233 is somewhat distinct. The flared edge 2233 may be created during a second step in an injection mold process, integrally formed with the remainder of the lid 2200, or a frame that has been applied to the lid 2200 and the like.

Referring particularly to FIGS. 11 and 12, the dispenser 2000 is configured to allow one-handed removal of the recloseable storage bags through the slots 2210, 2220, 2230. The central extensions 2211, 2221, 2231 allow for pinching and grabbing by the consumer. In one embodiment, the bags have zipper closures that are staggered so that upon locating a single zipper closure, the zipper closure provides gripping tension to the consumer when removing the bag. The zipper closures may also be alternately interleaved to allow locating a single zipper closure in preparation for removing a single bag from the dispenser 2000. In another embodiment, the stack or roll of the bags has zipper closures that are staggered and alternately interleaved. In one embodiment, a roll is a plurality of individualized bags which have been stacked and then folded at least once to provide a unitized bundle. The roll would typically have a circular or oblong cross-sectional profile as well as many other shapes such are rectangular or trapezoidal.

Referring particularly to FIGS. 11, 14, 16 and 18, the lid 2200 includes a depending front lifting tab 2240 for opening and closing to provide full access to the base interior 2105. The lifting tab 2240 can serve as a single latch for securing the lid closed to the base 2100 with an audible noise to notify the consumer that the dispenser is closed. Opposing the lifting tab 2240 are two depending tabs 2242a, 2242b best seen in FIG. 18. The depending tabs 2242a, 2242b each define a hole 2244a, 2244b. The lifting tab 2240 and the depending tabs 2242a, 2242b engage the base 2100 for providing secure engagement of the lid 2200 thereto. The lid 2200 also includes a slightly recessed depending flange portion 2246 sized and configured to fit snugly within the base interior 2105. Thus, when coupled to the base 2100, the lid 2200 is not only securely held in place but provides a substantially uniform appearance with a minimal seam between the base 2100 and lid 2200.

In one embodiment, the lid 2200 is hinged to the base 2100 for easy one-handed operation. In another embodiment, the lid 2200 has an intermediate or central hinge that allows opening a portion of the lid 2200 to access the base interior 2105 for reloading the dispenser 2000. The lid 2100 can also be formed to mimic the shape of the refill bags such as a plurality of bags formed into a roll.

Referring now to FIG. 19, a perspective view of the base interior 2105 with two separators 2107a, 2107b and an optional divider 2109 for the in-home dispenser 2000 are shown. The base 2100 has two inwardly projecting tabs 2144a, 2144b for coupling into the holes 2244a, 2244b. To close the lid 2200, the tabs 2144a, 2144b are aligned into the holes 2244a, 2244b, then the lid lifting tab 2240 is pivoted onto the base 2100. The base 2100 also defines a recessed area 2140 that frictionally engages the lifting tab 2240 by snap fit means or the like.

Still referring to FIG. 19, the separators 2107a, 2107b define the three compartments 2110, 2120, 2130 along with the base 2100 and a plurality of optional dividers 2109. The base 2100 forms slots (not explicitly shown) for receiving the separators 2107a, 2107b. In another embodiment, the separators 2107a, 2107b are integrally formed with or formed in a subsequent step onto the base 2100. The separators 2107a, 2107b form notches 2111 to prevent interference with the flange portion 22246 of the lid 2200.

The base 2100 further defines a plurality of slots 2119 for receiving dividers 2109. By selectively adjusting placement of dividers 2109 in the slots 2119 the compartments 2110, 2120, 2130 can be sized to match the bag size and thus, providing axial compression of a roll of bags to create a desirable retentive force. The dividers 2109 also help prevent migration of the recloseable storage bags between compartments 2110, 2120, 2130. The base 2100 is also has contoured area 2162 so that each compartment conforms in shape to the respective roll, which further creates friction that furthers the desirable retentive force. As best seen in FIG. 14, the base 2100 has optional feet 2160. The feet 2160 may be tactile to provide gripping and secure placement.

Referring now to FIGS. 20(a)-(d), various views of a divider 2109 for use with the base 2100 of the in-home dispenser 2000 are shown. The divider 2109 has a planar body 2113 with an area 2115 for including branding information such as a logo or trademark. Each side of the body 2113 includes a ridge 2117 to facilitate coupling and secure insertion of the divider 2109 into a slot 2119.

Preferably, the refill bags are folded and formed into a roll to match the size and shape of the compartments 2110, 2120, 2130 of the dispenser 2000. In comparison to prior art coffin boxes, storing three different size rolls of bags in the dispenser 2000 will conserve space and allow for additional items to be presented in the drawer when partially opened. In one embodiment, the roll of bags has one or more bands applied thereto to maintain the desired shape. The banding can be elastic bands, paper or cardboard strips formed into a circle and secured by an adhesive, paper clips, flexible wrapping pouches, and the like. In preparation for retail sale, the dispenser 2000 is placed close to the merchandiser 90 and typically pre-filled with rolls of bags with dividers 2109 in place as appropriate. As noted above, the bags can be double C folded, then formed into a roll so that each zipper is positioned to provide gripping tension for the user when removing a recloseable storage bag from the dispenser through the respective access slot.

As can be seen, the dispenser 2000 has many advantages such as being able to fit in several orientations in a typical kitchen drawer. The dispenser 2000 can also be kept on a shelf, either vertically or horizontally. In a version without feet 2160, the base 2100 may be textured or otherwise coated to provide a non-slip surface to prevent sliding. The dispenser 2000 can even be mounted to a surface such as with a hook arrangement, two-way adhesive or hook-and-loop fabric. However, mounting is optional as the dispenser 2000 is designed to allow one-handed removal of bags without mounting as opposed to coffin boxes which require one hand to hold the box while a bag is removed. Despite retentive forces that are applied to the bags from the compartments, separators, dividers, slots and banding (or other packaging if not removed), the dispenser 2000 is weighted to overcome these factors and remain in place while using a single hand to pinch and grab a bag. In one embodiment, the dispenser weighs at least 60 grams per compartment in order to allow one-handed removal of a recloseable storage bag. It has been determined that a preferred retentive force to maintain the bags in a secured arrangement is typically overcome for dispensing by a force that can be more than counteracted by a dispenser weighing at least 60 grams. For a three slot/compartment dispenser, a preferred weight is at least 180 grams although a total 60 gram weight may still suffice for dispensing a single bag at a time. Various versions can be constructed to weigh at least 70, 80 or 90 grams per compartment more or less to tune the dispensing of bags for single-handed removal without undesirable lifting of the dispenser during bag removal. In the present technology, the weight of the dispenser is measured by measuring the total weight of the empty dispenser (e.g., the lid and base without bags) and then dividing that weight by the number of compartment to provide an average weight per compartment, or weight per compartment. The area 2250 may include a set of instructions directing consumers to (i) purchase at least one refill, (ii) open the lid, (iii) open the refill; (iv) place contents of the opened refill into one of the compartments, (v) close the lid onto the base; and (vi) remove one or more refill bags through the slot associated with the compartment.

In all of the configurations described herein, it should be understood that the configurations of the recloseable storage bags may be provided to the consumer ready to go out of any retail packaging, such as flexible packaging. However, in other embodiments, a user may be directed to further manipulate the recloseable storage bags for optimal use in any in-home dispensing unit that may be provided and/or otherwise used.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “50 mm” is intended to mean “about 50 mm.”

All documents cited herein are, in relevant part, incorporated herein by reference; the citation of any document is not to be construed as an admission that it is prior art with respect to the present technology. To the extent that any meaning or definition of a term in this written document conflicts with any meaning or definition of the term in a document incorporated by reference, the meaning or definition assigned to the term in this written document shall govern.

We claim:

1. A process of storing and retrieving recloseable storage bags comprising the steps of:
a) purchasing a package of two or more individualized recloseable storage bags from a retailer;
b) removing the two or more recloseable storage bags from the package;
c) optionally providing the two or more recloseable storage bags in a roll form;
d) inserting the roll of recloseable storage bags into a dispenser having one or more compartments, the dispenser further comprising a lid wherein the lid comprises one or more access slots juxtaposed over the one or more compartments; and
e) removing one or more recloseable storage bags from the dispenser through the one or more access slots.

2. A process as recited in claim 1, further comprising the step of packaging the individualized recloseable storage bags in a flexible-wrapped pouch.

3. A process as recited in claim 1, wherein the lid encloses the compartments and is hinged to open and close by one-handed operation.

4. A process as recited in claim 1, wherein the dispenser weighs at least 60 grams per compartment in order to allow one-handed removal of a recloseable storage bag.

5. A process as recited in claim 4, wherein the dispenser has three compartments and weighs at least 180 grams.

6. A process as recited in claim 4, wherein the dispenser weighs at least 70 grams per compartment.

7. A process as recited in claim 4, wherein the dispenser weighs at least 80 grams per compartment.

8. A process as recited in claim 4, wherein the roll is sized and configured to frictionally engage the dispenser from a first dispensed bag to a last dispensed bag so that only one-handed dispensing is necessary.

9. A process as recited in claim 1, wherein the recloseable storage bags include zipper closures.

10. A process as recited in claim 9, further comprising the steps of:
stacking the recloseable storage bags so that the zipper closures are aligned;
folding a bottom end of the recloseable storage bags evenly onto a mouth of the recloseable storage bags;
folding the middle of the once folded recloseable storage bags evenly onto the mouths/bottom ends; and
forming the folded stack of the recloseable storage bags into the roll.

11. A process as recited in claim 10, further comprising the step of banding the roll to maintain a desired shape with a band selected from the group consisting of an elastic band, a paper or cardboard strip formed into a circle, a paper clip, a flexible wrapping pouch, and combinations thereof.

12. A process as recited in claim 10, wherein each zipper is positioned to provide gripping tension for the user when removing a recloseable storage bag from the dispenser through the respective access slot.

13. A process as recited in claim 1, wherein the dispenser is molded plastic.

14. A process as recited in claim 1, further comprising the steps of:
providing a merchandiser, wherein the merchandiser contains at least three different types of bags packaged as refills, wherein the different types of bags are packaged as a plurality of bags within a flexible bag; and
providing a set of instructions with at least one of the merchandiser and the storage dispenser for directing the consumers to replenish the dispenser with the at least two different types of bags.

15. A process as recited in claim 14, further comprising the steps of pre-filling the merchandiser and the dispenser with refills for display and sale in a retail environment.

16. A process as recited in claim 14, wherein the set of instructions directs consumers to
(i) purchase at least one refill,
(ii) open the lid,
(iii) open the refill;
(iv) place contents of the opened refill into one of the compartments,
(v) close the lid onto the base; and
(vi) remove one or more refill bags through the slot associated with the compartment.

17. A process as recited in claim 1, wherein in a closed position:
a length of the dispenser is approximately from 8 inches to approximately 14 inches;
a width of the dispenser is from approximately 6 inches to approximately 12 inches;
a height of the dispenser is less than approximately 3 inches so that the storage dispenser fits in most drawers in two orientations; and
the dispenser two slots being approximately 170 mm by 23 mm and the third slot being approximately 260 mm by 23 mm, each access slot including a central extension void that is approximately 57 mm wide for allowing pinch and grabbing of the bags in the associated compartment.

18. A process as recited in claim 1, wherein the lid includes a single latch for securing the lid closed to the base with an audible noise to notify to a consumer that the dispenser is closed and allowing for single handed opening of the dispenser.

19. A process as recited in claim 1, wherein each compartment conforms in shape to the respective roll, and further including dividers that are adjustable in slots sized to prevent migration of the recloseable storage bags between compartments.

20. A process as recited in claim 1, further comprising providing a volume insert in at least one of the compartments of the dispenser, wherein the volume insert is selected from the group consisting of a semi-cylinder, a folded planar sheet, and a planar sheet with at least two folds.
